(19) United States
(12) Patent Application Publication
(10) Pub. No.: US 2004/0229489 A1
(43) Pub. Date: Nov. 18, 2004

(54) Circuit-toy assembly kit

(76) Inventor: Xiaocheng Lu, Walnut, CA (US)

Correspondence Address: Raymond Y. Chan, Suite 128, 108 N. Ynez Ave., Monterey Park, CA, 91754, US

(21) Appl. No.: 10/696,248

(22) Filed: Oct. 28, 2003

Related U.S. Application Data
(63) Continuation-in-part of application No. 10/385,267, filed on Mar. 9, 2003.

(51) Int. Cl. H01R 4/60

(52) U.S. Cl. 439/214

(57) ABSTRACT

A circuit-toy assembly kit includes a plurality of connector units each including a supporting frame, two terminal fasteners spacedly affixed to the supporting frame, and a terminal circuit electrically connecting with the terminal fasteners. Each terminal fastener has an inserting head upwardly extended from a first side of the supporting frame and a socket housing integrally extended from the inserting head and defining a receiving socket on a second side of the supporting frame, wherein the inserting head is shaped and sized corresponding to the receiving socket. Therefore, the connector units are selectively connected together by detachably inserting the inserting head of the terminal fastener of one of the connector units into the receiving socket another connector unit to structurally connect the supporting frames and to electrically connect the terminal circuits so as to form the electronic circuit.

### CROSS-REFERENCE OF RELATED APPLICATION

This is a Continuation-In-Part application of a non-provisional application having an application Ser. No. 10/385,267 and a filing date of Mar. 9, 2003.

### BACKGROUND OF THE PRESENT INVENTION

1. Field of Invention

The present invention is relates to a circuit assembly, and more particularly to a circuit-toy assembly kit, which comprises a plurality of connector units structural and electrically connected with each other to form a closed electronic circuit.

2. Description of Related Arts

The assembling operation of a conventional battery-operated electronic product, such as electronic toy, generally requires a particular connector to connect the assembling parts together to form a closed circuit. A typical connector to connect the assembling parts is a screw wherein the user must use a screwdriver as a tool to incorporate with the assembling operation of the battery-operated electronic product. However, it is difficult for a child to handle the screwdriver during the assembling operation especially the battery-operated electronic product is made as the electronic toy for children.

An improved connector, which is commonly used for the assembling operation of the battery-operated electronic product, is a hand held screw to connect the assembling parts without using the screwdriver. However, the hand held screw cannot provide a secure electrical connection between the assembling parts. In addition, it is a burden that the hand held screw must be tight enough not only to connect the assembling parts together but also to ensure the electrical connection therebetween. Thus, it is chance that the hand held screw is missing such that the assembling operation of the battery-operated electronic product cannot be completed. In other words, the above mentioned connectors are disadvantage in practical use.

### SUMMARY OF THE PRESENT INVENTION

A main object of the present invention is to provide a circuit-toy assembly kit, which comprises a plurality of connector units structural and electrically connected with each other to form a closed electronic circuit

Another object of the present invention is to provide a circuit-toy assembly kit, which incorporates with a modified snap connector to connect the connector units with each other for not only securing the structural connection between the connector units but also ensuring the electrical connection the connector units to form an electronic circuit therebetween.

Another object of the present invention is to provide a circuit-toy assembly kit, wherein the connector unit further comprises a circuit functional element, such as a capacitor, a battery holder, or a light assembly, so as to enhance the interest in building up the electronic circuit.

Another object of the present invention is to provide a circuit-toy assembly kit, which provides a convenient and rapid connection between the connector units by simply snapping the two connector units together.

Another object of the present invention is to provide a circuit-toy assembly kit, which can be simply used in the building block that allow a child to play with so as to implement the child in a sense of building structure and electric circuit connection at the same time. In other words, the child is able to easily and conveniently build the electronic toy via the connector units.

Another object of the present invention is to provide a circuit-toy assembly kit, which has a simple structural design so as to minimize the manufacturing cost of the present invention. In addition, the connector unit can be repeatedly used for connection such that the user is able to reconstruct the electronic toy without damaging the connection between the two connector units.

Another object of the present invention is to provide a circuit-toy assembly kit, wherein the connector unit can be configured in any shape and color, such as traditional or cartoon style, to keep the aesthetic appearance of the electronic toy.

Another object of the present invention is to provide a circuit-toy assembly kit, wherein the connector unit functions as an electrical terminal adapted to build multiple electronic circuits for electronic toys so as to encourage imagination and creativity of the user. In addition, the circuit-toy assembly kit of the present invention is adapted to support any battery-operated electronic toy, which is a safe and expandable connector for the electronic toy.

Another object of the present invention is to provide a circuit-toy assembly kit, which can be considered as an electronic design test to configure the electronic circuit of the electronic toy. Therefore, the circuit-toy assembly kit can be used to build simple or complicated circuit diagrams for the electronic toy.

Accordingly, in order to accomplish the above objects, the present invention provides a circuit-toy assembly kit, comprising a plurality of connector units, wherein each of the connector units comprises:

a supporting frame having a first side and an opposed second side;

at least two terminal fasteners spacedly affixed to the supporting frame, wherein each of the terminal fasteners has an inserting head upwardly extended from the first side of the supporting frame and a socket housing integrally extended from the inserting head and defining a receiving socket on the second side of the supporting frame, wherein the inserting head is shaped and sized corresponding to the receiving socket so as to allow the inserting head to detachably insert into the receiving socket; and

a terminal circuit supported by the supporting frame to electrically connect the terminal fasteners with each other;

wherein the connector units are selectively connected with each other to form an electronic circuit by detachably inserting the inserting head of the terminal fastener of one of the connector units into the receiving socket of the terminal fastener of another connector unit to structurally connect the supporting frames with each other and to electrically connect the terminal circuits with each other so as to form the electronic circuit.

These and other objectives, features, and advantages of the present invention will become apparent from the following detailed description, the accompanying drawings, and the appended claims.

### BRIEF DESCRIPTION OF THE DRAWINGS

In the drawings, closely related figures have the same number but different alphabetic suffixes.

FIG. 1 is an example to show the invention in battery-operated electronic light circuit diagram that shows how the invention connects to the circuit.

FIG. 1A shows the circuit-toy assembly kit being use for connecting several parts together.

FIGS. 2A, B, C show the structure of terminal fastener.

FIGS. 3A and B show one terminal fastener connected to another terminal fastener and their structures.

FIGS. 4A, B, and C show a connector unit.

FIGS. 5A, B, and C show the connector unit installed with a circuit functional element.

FIGS. 6A, B, C, D, and E show the assembly board and connector unit attached on the assembly board.

FIG. 7 is a perspective view of a toy assembly kit to form an electronic circuit according to a second preferred embodiment of the present invention.

FIG. 8 is a sectional view of a connector unit of the toy assembly kit according to the above second preferred embodiment of the present invention.

FIG. 9 is a perspective view of the terminal fastener of the toy assembly kit according to the above second preferred embodiment of the present invention.

FIG. 10 is a basic light circuit formed by the toy assembly kit according to the above second preferred embodiment of the present invention.

FIG. 11 is a push-button music doorbell circuit formed by the toy assembly kit according to the above second preferred embodiment of the present invention.

FIG. 12 is an adjustable light sensitive fan circuit formed by the toy assembly kit according to the above second preferred embodiment of the present invention.

FIG. 13 is a FM radio with adjustable channel circuit formed by the toy assembly kit according to the above second preferred embodiment of the present invention.

### DETAILED DESCRIPTION OF THE PREFERRED EMBODIMENT

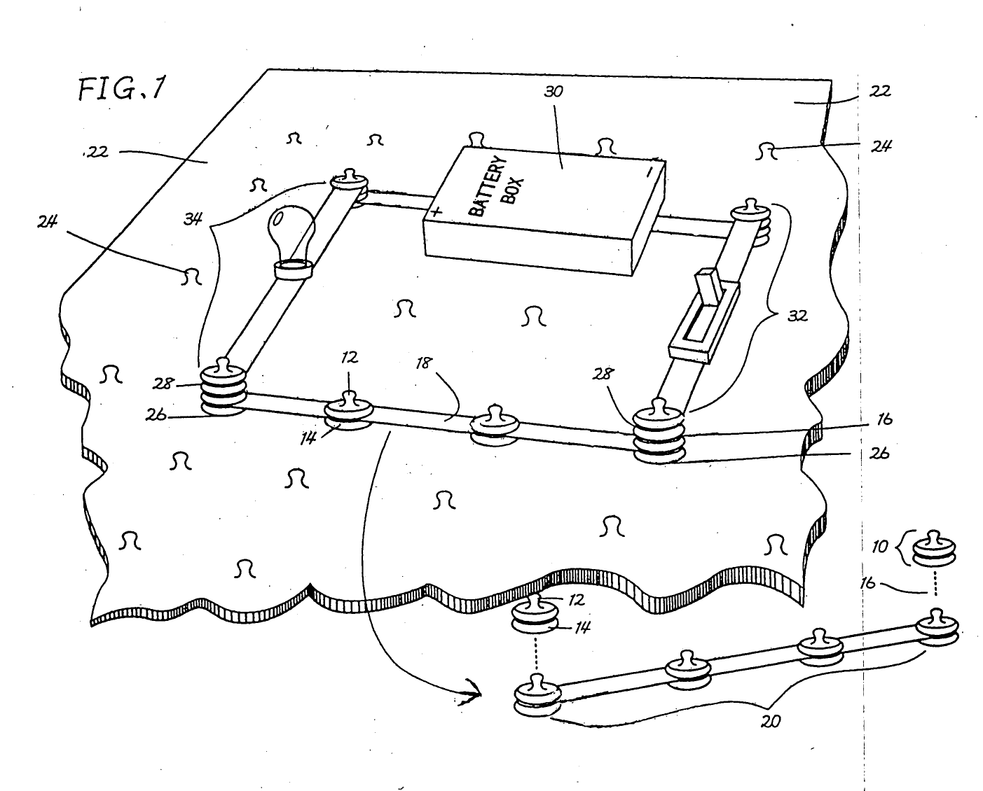

As shown in FIG. 1, an example of the invention is to show the circuit-toy assembly kit in the battery-operated electronic light circuit diagram that demonstrates how the invention connects to the circuit. FIG. 1 illustrates that when the switch 32 is on, the light bulb will illuminate. This is nor remarkable, but is on builds the battery-operated electronic light circuit diagram successfully in 10 seconds that may be amazing. In fact, the invention can be used to build not only the battery-operated electronic light circuit, but also other complicated electronic circuits which can be built successfully and conveniently in a short time. Let's describe how to build the Battery-operated electronic light circuit. First, put the battery holder with connector 30 on the fixed male connector 24 in a desired position of the assembly board 22, and then snap the connector group 20 on the fixed male connector 24 in an opposed position from the battery holder with connector 30. Next, connect the connector with attached electronic part 28 of the light-bulb assembly 34 on other connector with attached electronic part 28 of battery holder 30, and other connector with attached electronic part 28 snap to male connector part 12 of the connector group 20. Last step, connect the connector with attached electronic part 28 of power switch 32 to connector with attached electronic part 28 of battery holder 30 and other male connector part 12 of connector group 20 so that the battery-operated light circuit is completed. The procedures are easy, convenient, and rapid. The key to the simplicity of using this system for electronic toys or various designs is the ease of snap together connector system.

It is worth to mention that:

(1) for structuring and operational reasons, each of the fixed male connectors 24 of the assembly board 22 has a size and shape matching the male connector part 12 and the female connector part 14;

(2) the rule of distance between each two fixed male connector 24 of the assembly board 22 should be equal, wherein if using vertical and horizontal lines to link all the fixed male connectors 24, the circuit would form as a square;

(3) the base connector 10 combines with electronic part 28 or connector group 20 whose position and distance should match the standard of fixed male connector 24 of the assembly board 22, but allows installing only male connector part 12 or female connector part 14 if the electronic part 28 or connector 20 is needed, and also for the combination of the electronic part 28 or connector group 20, some fixed male connectors 24 may be unused;

(4) for product design matching reasons, the base connector 10, the connector group 20, and the fixed male connector 24 of the assembly board 22 may have different shapes, materials, or colors, without changing the basic idea of the invention;

(5) all connectors to be made of material that conducts electric current of suitable intensity while the fixed male connector 24 of the assembly board 22 is made of material that is dielectric (i.e. plastic);

(6) the male and female connector parts 12, 14 are formed in one connector, wherein the male connector part 12 is on top and the female connector part 14 is on bottom, which position is opposite, in addition, the position of the female connector part 14 can be on top and the male connector part 12 can be on the bottom; and

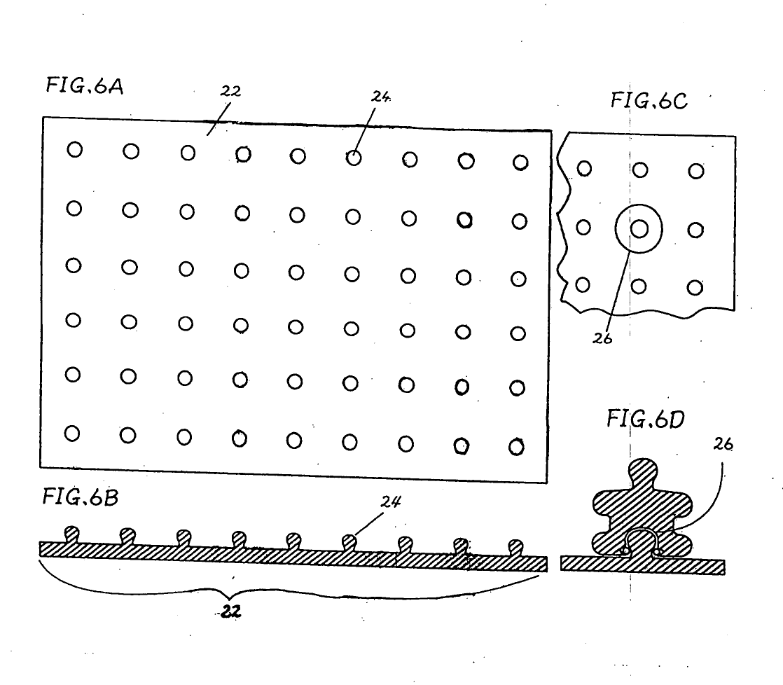

(7) the assembly board 22 could also be manufactured as a fixed: female connector assembly board 40 if it is desired, as shown in FIG. 6E.

FIG. 1A as a part of FIG. 1 that shows more detail structures of connector 20, the condition between two connectors 16, the condition between connector and fixed male connector of assembly board 26, the connector with attached electronic part 28, and the connector metal wire 18.

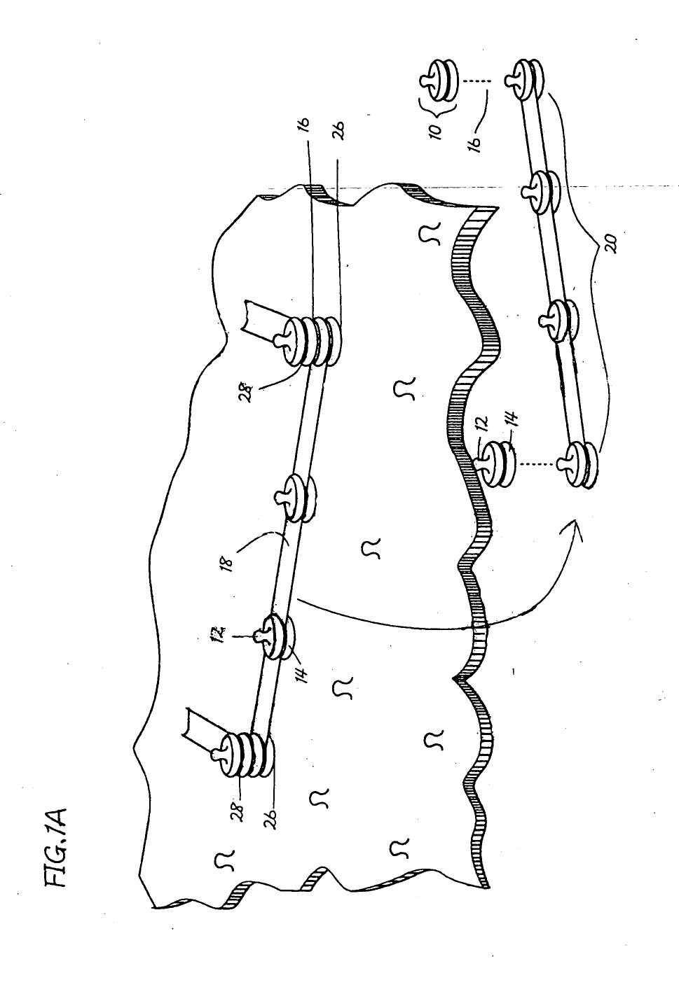

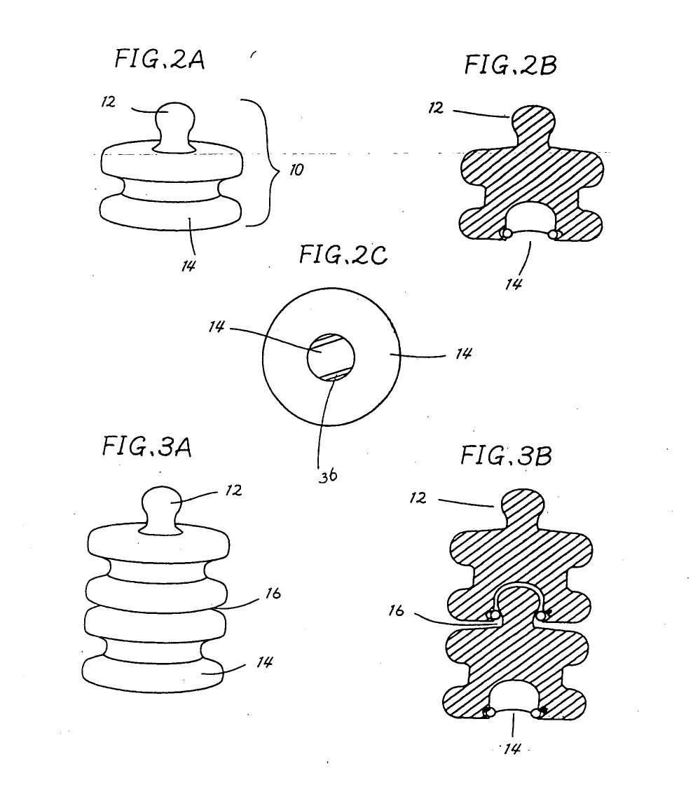

FIG. 2A shows the structure of base connector 10 that includes the male connector part 12 and the female connector part 14, which positions are opposite. This is the base connector in the circuit-toy assembly kit. It functions for the connection. When the male connector part 12 or the female connector part 14 connects to connector metal wire 18, the electronic circuit should be completed.

FIG. 2B is a sectional view to show the structures of male connector part 12 and the female connector part 14 of the base connector 10.

FIG. 2C is an end view presents structure of the female connector part 14. The metal thread of female connector part 36 can contact the male connector part 12 when one base connector 10 connects to others.

The base connector 10 is the most important part of the invention. Its structure can be solid or hollow depending on material savings, strength, or other considerations, but cannot affect the function of the base connector 10. Also, the base connector can be used alone or can be a part of the connector group 20 if it is necessary.

FIGS. 3A and 3B present the condition between two connectors 16. FIGS. 3A and 3B shows the male connector part 12 connected to the female connector part 14, wherein more base connectors 10 may be added above or below for a variety of connective applications.

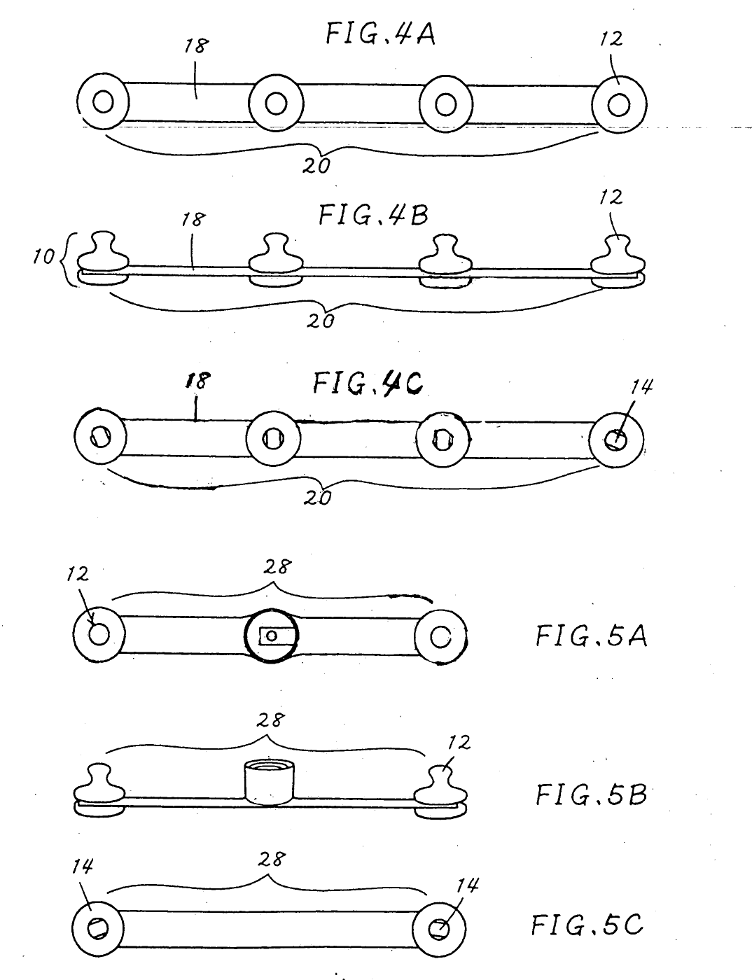

FIGS. 4A, 4B, and 4C show the connector group 20 in different ways. The connector group 20 has 4 base connectors 10. In fact, if it is necessary, additional base connectors 10 may be added to support different demands. Using the connector metal strip 18 to links one base connector 10 with other base connector 10 together, a simple circuit as the connector group 20 is formed.

FIGS. 5A, 5B, and 5C are a top view, end view, and bottom view of the connector group 20 respectively. The connector group 20 with the base connectors 10 installs to an electronic part-light bulb, so it becomes a connector group 20 attached with electronic part 28. The connector group 20 with attached electronic part 28 is just an example to show how the base connector 10 connects to the electronic parts 28. It can be any electronic part. For example, the connector group 20 can install to IC, battery holder, microphone, motor; etc. The only requirement must follow the rule of distance that means the position and distance of the base connectors 10 should match the fixed male connector 24 of the assembly board 22 when installing the connector group 20 to the electronic part 28.

FIGS. 6A, 6B, 6C, and 6D show the assembly board 22 having the fixed male connectors 24 and condition when the base connector 10 is fixed on the assembly board 22. The assembly board 22 must be made of dielectric material. Also, its size based on product's design of the connector group 20.

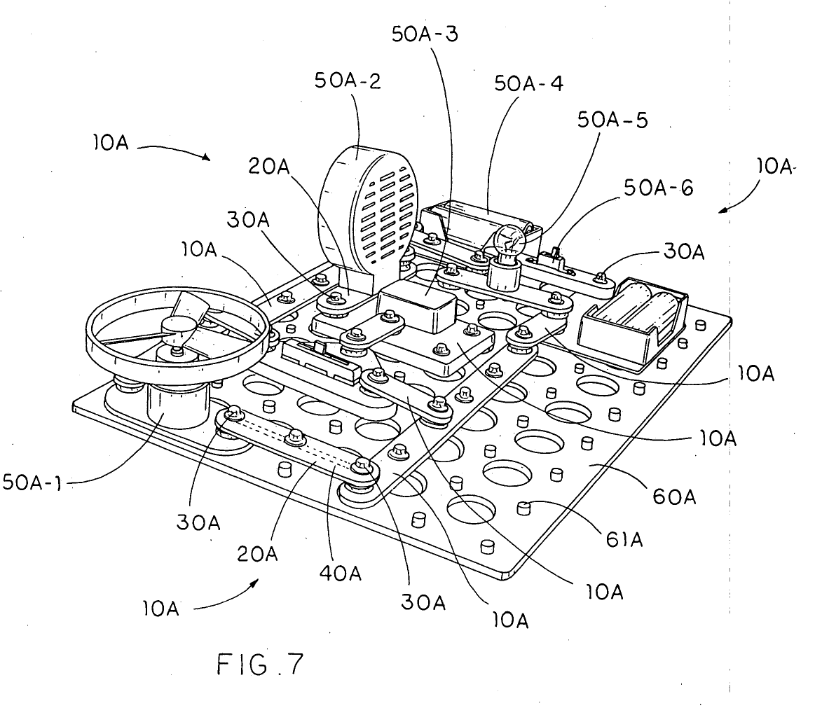

As shown in FIGS. 7 to 9, a circuit-toy assembly kit according to a second embodiment illustrates an alternative mode of the above first preferred embodiment of the present invention.

According to the second preferred embodiment, the circuit-toy assembly kit comprises a plurality of connector units 10A, arranged to connect with each other to form an electronic circuit, wherein the connector unit 10A is embodied as the connector group 20 of the above first embodiment. Each of the connector units 10A comprises a supporting frame 20A having a first side 21A and an opposed second side 22A, at least two terminal fasteners 30A spacedly affixed to the supporting frame 20A, and a terminal circuit 40A supported by the supporting frame 20A to electrically connect the terminal fasteners 30A with each other.

Each of the terminal fasteners 30A has an inserting head 31A upwardly extended from the first side 21A of the supporting frame 20A and a socket housing 32A integrally extended from the inserting head 31A and defining a receiving socket 321A on the second side 22A of the supporting frame 20A, wherein the inserting head 31A is shaped and sized corresponding to the receiving socket 321A so as to allow the inserting head 31A to detachably insert into the receiving socket 321A.

Therefore, the connector units 10A are selectively connected with each other to form the electronic circuit by detachably inserting the inserting head 31A of the terminal fastener 30A of one of the connector units 10A into the receiving socket 321A of the terminal fastener 30A of another connector unit 10A to structurally connect the supporting frames 20A with each other and to electrically connect the terminal circuits 40A with each other so as to form the electronic circuit.

According to the second embodiment, the supporting frame 20A is made of dielectric material such as plastic to support the terminal fasteners 30A and the terminal circuit 40A. The supporting frame 20A supports the terminal fasteners 30A thereon to retain the terminal fasteners 30A with a predetermined distance therebetween. Accordingly, the supporting frame 20A can be constructed to have various sizes and shapes such as elongated shape or triangular shape.

Each of the terminal fasteners 30A is made of electric conducting material. The inserting head 31A of each of the terminal fasteners 30A has a mounting disc 311A mounted on the first side 21A of the supporting frame 20A, a narrowed neck portion 312A upwardly and integrally extended from the mounting disc 331A, and an enlarged buckle head 313A having a diameter substantially larger than the narrowed neck portion 312A, wherein the receiving socket 321A of the terminal fastener 30A of the connector unit 10A is shaped and sized for detachably receiving and retaining the inserting head 31A of the terminal fastener 30A of another connector unit 10A therein.

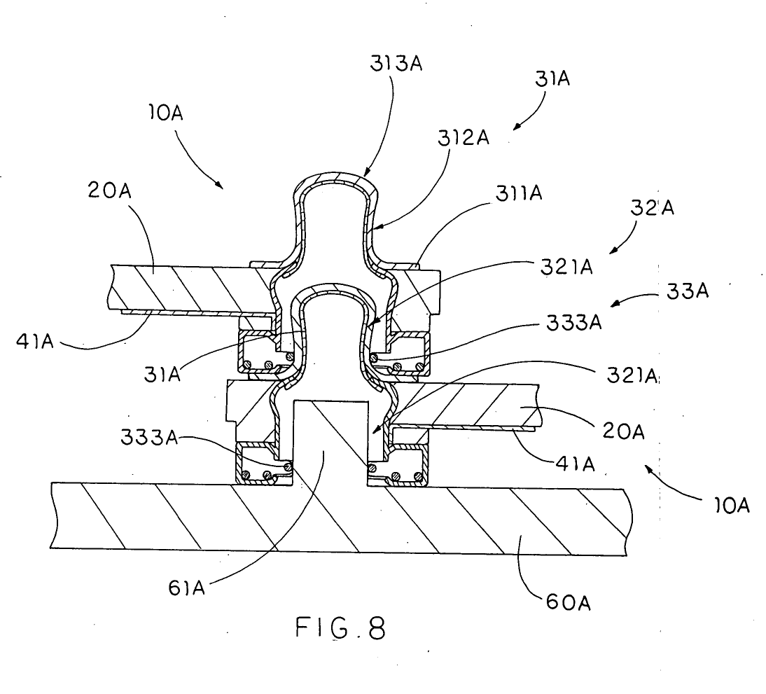

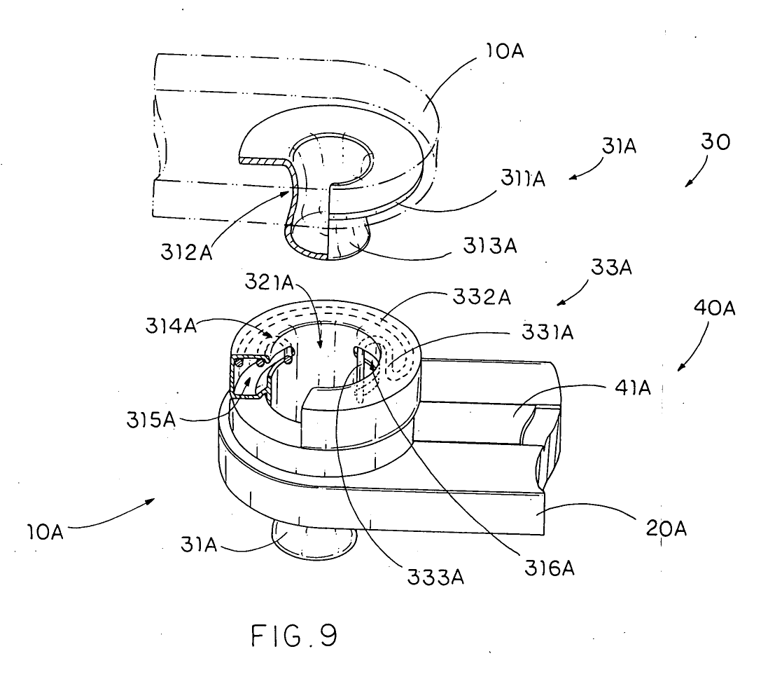

As shown in FIGS. 8 and 9, each of the terminal fasteners 30A further comprises a resilient element 33A formed at an opening portion of the receiving socket 321A for applying a retaining force against the narrowed neck portion 312A of another terminal fastener 30A when the inserting head 31A of another terminal fastener 30A is inserted into the receiving socket 321A of the terminal fastener 30A.

Accordingly, each of the socket housings 32A has a circular loop shoulder 314A formed around the opening portion of the receiving socket 321A to define a circular chamber 315A surrounding the opening portion of the receiving socket 321A and two opposed guiding slots 316A provided along a sidewall of the opening portion of the receiving socket 321A to communicate with the circular chamber 315A of the loop shoulder 314A.

The resilient element 33A has two S-shaped end portions 331A and a semi-circular middle arc portion 332A connected between the two ends portions 331A being arranged inside the circular chamber 315A of the loop shoulder 314A, wherein the middle arc portion 332A of the resilient element 33A is propped against an outer wall of the loop shoulder 314A to support two straight end tails 333A of the two end portions 331A respectively extending into the receiving socket 321A of the socket housing 32A through the two guiding slots 316A, wherein the two end tails 333A are parallelly disposed to define a distance therebetween and smaller than a diameter of the receiving socket 321A.

Therefore, when the inserting head 31A is inserted into the receiving socket 321A of the socket housing 32A, the buckle head 313A of the inserting head 31A is slidably inserted through the opening portion of the receiving socket 321A between the two end tails 333A of the resilient element 33A. Due to the elastic ability of the resilient element 33A, the two end tails 333A of the resilient element 33A are bounced outwardly along the guiding slots 316A respectively to allow the buckle head 313A of the inserting head 31A to pass between the two end tails 333A of the resilient element 33A. As a result, when the inserting head 31A is inserted into the receiving socket 321A, the two end tails 333A of the resilient element 33A are positioned at the narrowed neck portion 312A of the inserting head 31A, so as to retain the inserting head 31A within the receiving socket 321A.

Therefore, the user is able to rapidly connect the two connector units 10 together by snapping the terminal fasteners 30A with each other. Thus, the connector units 10 are adapted to be detached and re-attached via the terminal fasteners 30A without damaging its structure.

As shown in FIG. 8, the terminal circuit 40A comprises an elongated conduction strip 41A mounted on the second side 22A of the supporting frame 20A to electrically connect the terminal fasteners 30A with each other. Accordingly, the conduction strip 41 is made of electrical conduction material, such as metal, which is mounted along the second side 22A of the supporting frame 20A and is extended between the terminal fasteners 30A.

According to the second embodiment, the connector unit 10A further comprises a circuit functional element 50A substantially supported by the supporting frame 20A to electrically connect with the terminal fasteners 30A through the terminal circuit 40A for performing a predetermined circuit function when the electronic circuit is formed. As shown in FIG. 7, the circuit functional element 50A is embodied as a light bulb socket mounted on the supporting frame 20A to electrically connect the terminal fasteners 30A through the terminal circuit 40A, in such a manner that when the connector units 10A are electrically connected to a power source to form the electronic circuit, a light bulb mounted on the light bulb socket of the circuit functional element 50A is electrically connected to the power source through the connector units 30A. Accordingly, the circuit functional element 50A can be a switch control such as a light control, magnetic control, motor control, sound control, touch control, or vibration control. In addition, the circuit functional element 50A can be a buzzer, reed relay, photo-resistor, LED, an IC, a battery holder, a microphone, a motor, an antenna coil, a resistor, a capacitor, a transistor, etc depending on the circuit configuration.

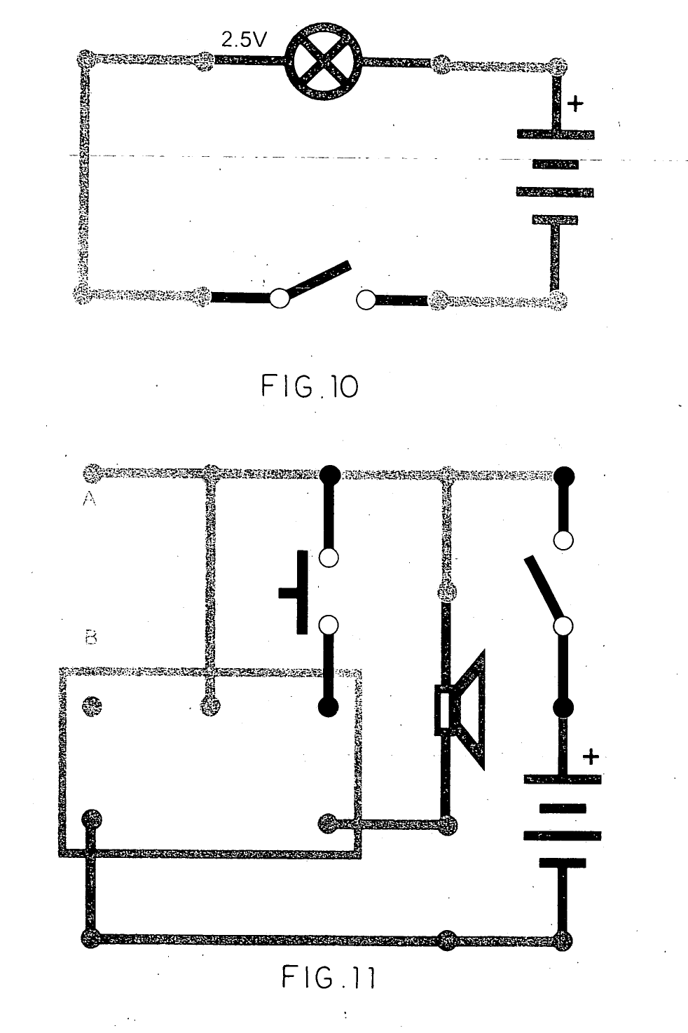

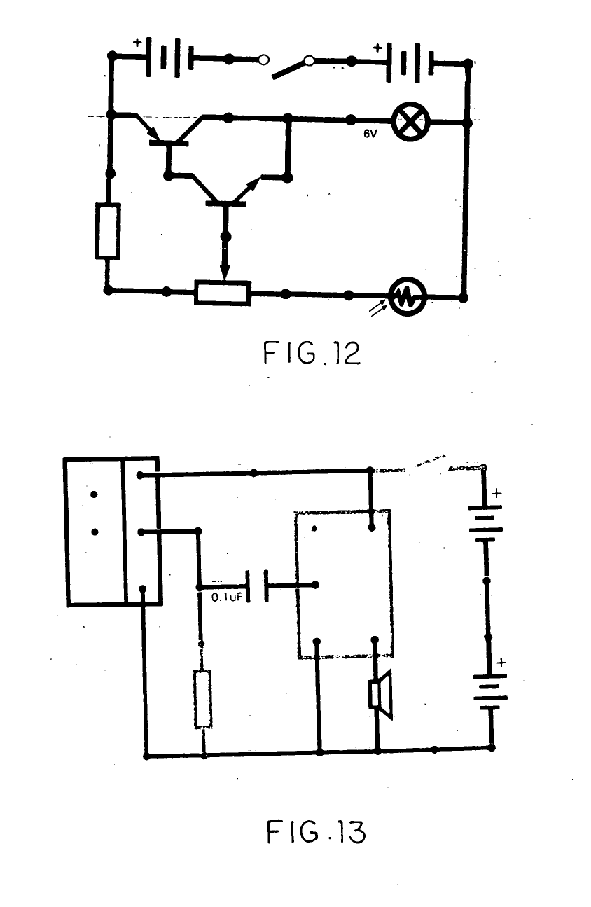

Therefore, by selectively connecting the connector units 10A with the circuit functional elements 50A, hundreds of electronic circuits can be formed, as shown in FIGS. 10 to 13. It is worth to mention that the electronic circuits shown in FIGS. 10 to 13 are only for illustrating parts of the combination of the connector units 10A such that the user, i.e. the player, is able to build his or her own electronic circuit through his or her imagination and creativity.

FIG. 7 illustrates an example of using various circuit functional elements 50A to form the electronic circuit. As shown in FIG. 7, a plurality of the connector units 10A are structurally and electrically connected with each other, wherein the circuit functional elements 50A used in the circuit are respectively a motor 50A-1, a buzzer 50A-2, a power amplifier 50A-3, a battery holder 50A-4, a light bulb holder 50A-5, and a manual switch 50A-6.

It is worth to mention that the connector unit 10A can be constructed to have one single terminal fastener 30A as a circuit adapter to structurally and electrically connect with other two connector units 10A by connecting the single terminal fastener 30A of the connector unit 10A between the two other connector units 10A. Accordingly, the inserting head 31A is integrally extended from the socket housing 32A to form as the terminal circuit 40A such that the single terminal fastener 30A are electrically connected to the two other connector units 10A when the two other connector units 10A are connected thereto.

The circuit-toy assembly kit further comprises an assembly platform 60A having a plurality of guiding members 61A spacedly and upwardly protruded thereon to detachably insert into the receiving sockets 321A of the terminal fasteners 30A respectively so as to support the connector units 10 on the assembly platform 60A, wherein the connector units 10A are selectively mounted to the assembly platform 60A to form the electronic circuit on the assembly platform 60A.

The assembly platform 60A, which is made of dielectric material such as plastic, functions as an insulating supporting platform to support the connector units 10A thereon so as to prevent the short circuit of the electronic circuit when the connector units 10A are electrically connected together on the assembly platform 60A. The guiding members 61A are integrally and evenly extended from the assembly platform 60A to detachably insert into the receiving sockets 321A of the terminal fasteners 30A respectively so as to retain each of the connector units 10A on the assembly platform 60A in position to ensure the structural and electrical connection between the connector units 10A.

Accordingly, each two terminal fasteners 30A of the connector units 10A has a predetermined distance that when the connector unit 10A is mounted on the assembly platform 60A, the terminal fasteners 30A are fittingly engaged with the two corresponding guiding members 61A so as to substantially retain the connector unit 10A on the assembly platform 60A to electrically connect with another connector unit 10A, as shown in FIG. 7.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A circuit-toy assembly kit for constructing an electronic circuit, comprising a plurality of connector units, wherein each of said connector units comprises:
a supporting frame having a first side and an opposed second side;
at least two an electric conductive terminal fasteners spacedly affixed to said supporting frame, wherein each of said terminal fasteners has an inserting head upwardly extended from said first side of said supporting frame and a socket housing integrally extended from said inserting head and defining a receiving socket on said second side of said supporting frame, wherein said inserting head is shaped and sized corresponding to said receiving socket so as to allow said inserting head of said terminal fastener to insert into said receiving socket of another said terminal fastener in a detachably connecting manner; and
a terminal circuit supported by said supporting frame to electrically connect said terminal fasteners with each other;
wherein each of said terminal fasteners further comprises a resilient element formed at an opening portion of said receiving socket for applying a retaining force against said inserting head of another said terminal fastener when said inserting head of another said terminal fastener is inserted into said receiving socket of said terminal fastener, so as to securely connect said two connector units in an electrical connecting manner;
wherein said connector units are selectively connected with each other to form said electronic circuit by detachably inserting said inserting head of said terminal fastener of one of said connector units into said receiving socket of said terminal fastener of another said connector unit to structurally connect said supporting frames with each other and to electrically connect said terminal circuits with each other so as to form said electronic circuit.

2. The circuit-toy assembly kit, as recited in claim 1, wherein said inserting head of each of said terminal fasteners has a mounting disc mounted on said first side of said supporting frame, a narrowed neck portion upwardly and integrally extended from said mounting disc, and an enlarged buckle head having a diameter substantially larger than said narrowed neck portion, wherein said receiving socket of said terminal fastener of said connector unit is shaped and sized for detachably receiving and retaining said inserting head of said terminal fastener of another said connector unit therein.

3. The circuit-toy assembly kit, as recited in claim 1, wherein each of said socket housings has a circular loop shoulder formed around said opening portion of said receiving socket to define a circular chamber surrounding said opening portion of said receiving socket and two opposed guiding slots provided along a sidewall of said opening portion of said receiving socket to communicate with said circular chamber of said loop shoulder, wherein said resilient element has two S-shaped end portions and a semi-circular middle arc portion connected between said two ends portions being arranged inside said circular chamber of said loop shoulder, wherein said middle arc portion of said resilient element is propped against an outer wall of said loop shoulder to support two straight end tails of said two end portions respectively extending into said receiving socket of said socket housing through said two guiding slots, wherein said two end tails are parallelly disposed to define a distance therebetween and smaller than a diameter of said receiving socket, such that when said inserting head is inserted into the receiving socket, said two end tails of said resilient element are bounced outwardly along said guiding slots respectively to allow said buckle head of said inserting head to pass between said two end tails of said resilient element while said two end tails of said resilient element are retained at said narrowed neck portion of said inserting head so as to retain said inserting head within said receiving socket.

4. The circuit-toy assembly kit, as recited in claim 2, wherein each of said socket housings has a circular loop shoulder formed around said opening portion of said receiving socket to define a circular chamber surrounding said opening portion of said receiving socket and two opposed guiding slots provided along a sidewall of said opening portion of said receiving socket to communicate with said circular chamber of said loop shoulder, wherein said resilient element has two S-shaped end portions and a semi-circular middle arc portion connected between said two ends portions being arranged inside said circular chamber of said loop shoulder, wherein said middle arc portion of said resilient element is propped against an outer wall of said loop shoulder to support two straight end tails of said two end portions respectively extending into said receiving socket of said socket housing through said two guiding slots, wherein said two end tails are parallelly disposed to define a distance therebetween and smaller than a diameter of said receiving socket, such that when said inserting head is inserted into the receiving socket, said two end tails of said resilient element are bounced outwardly along said guiding slots respectively to allow said buckle head of said inserting head to pass between said two end tails of said resilient element while said two end tails of said resilient element are retained at said narrowed neck portion of said inserting head so as to retain said inserting head within said receiving socket.

5. The circuit-toy assembly kit, as recited in claim 1, wherein at least one of said connector units further a circuit functional element substantially supported by said supporting frame to electrically connect with said terminal circuit for performing a predetermined circuit function when said electronic circuit is formed.

6. The circuit-toy assembly kit, as recited in claim 2, wherein at least one of said connector units further a circuit functional element substantially supported by said supporting frame to electrically connect with said terminal circuit for performing a predetermined circuit function when said electronic circuit is formed.

7. The circuit-toy assembly kit, as recited in claim 4, wherein at least one of said connector units further a circuit functional element substantially supported by said supporting frame to electrically connect with said terminal circuit for performing a predetermined circuit function when said electronic circuit is formed.

8. The circuit-toy assembly kit, as recited in claim 2, further comprising an assembly platform having a plurality of guiding members spacedly and upwardly protruded thereon to detachably insert into said receiving sockets of said terminal fasteners respectively, wherein said connector units are selectively mounted to said assembly platform to form said electronic circuit on said assembly platform.

9. The circuit-toy assembly kit, as recited in claim 4, further comprising an assembly platform having a plurality of guiding members spacedly and upwardly protruded thereon to detachably insert into said receiving sockets of said terminal fasteners respectively, wherein said connector units are selectively mounted to said assembly platform to form said electronic circuit on said assembly platform.

10. The circuit-toy assembly kit, as recited in claim 7, further comprising an assembly platform having a plurality of guiding members spacedly and upwardly protruded thereon to detachably insert into said receiving sockets of said terminal fasteners respectively, wherein said connector units are selectively mounted to said assembly platform to form said electronic circuit on said assembly platform.

11. The circuit-toys assembly kit, as recited in claim 8, wherein said assembly platform, which is made of dielectric material, functions as an insulating supporting platform to support said connector units thereon.

12. The circuit-toys assembly kit, as recited in claim 9, wherein said assembly platform, which is made of dielectric material, functions as an insulating supporting platform to support said connector units thereon.

13. The circuit-toys assembly kit, as recited in claim 10, wherein said assembly platform, which is made of dielectric material, functions as an insulating supporting platform to support said connector units thereon.

14. The circuit-toys assembly kit, as recited in claim 8, wherein said two terminal fasteners of said connector units has a predetermined distance that when said connector unit is mounted on said assembly platform, said terminal fasteners are fittingly engaged with said two corresponding guiding members so as to substantially retain said connector unit on said assembly platform to electrically connect with another said connector unit.

15. The circuit-toys assembly kit, as recited in claim 10, wherein said two terminal fasteners of said connector units has a predetermined distance that when said connector unit is mounted on said assembly platform, said terminal fasteners are fittingly engaged with said two corresponding guiding members so as to substantially retain said connector unit on said assembly platform to electrically connect with another said connector unit.

16. The circuit-toys assembly kit, as recited in claim 13, wherein said two terminal fasteners of said connector units has a predetermined distance that when said connector unit is mounted on said assembly platform, said terminal fasteners are fittingly engaged with said two corresponding guiding members so as to substantially retain said connector unit on said assembly platform to electrically connect with another said connector unit.

17. A connector unit for constructing an electronic circuit, comprising:
a supporting frame having a first side and an opposed second side; and
at least an electric conductive terminal fastener affixed to said supporting frame, wherein said terminal fastener has an inserting head upwardly extended from said first side of said supporting frame and a socket housing integrally extended from said inserting head and defining a receiving socket on said second side of said supporting frame, wherein said inserting head is shaped and sized corresponding to said receiving socket;
whereby said connector unit is adapted to structurally and electrically connect with another said connector unit form said electronic circuit by detachably inserting said inserting head of said terminal fastener of said connector unit into said receiving socket of said terminal fastener of another said connector unit to structurally connect said supporting frames with each other and to electrically connect said terminal fasteners with each other so as to form said electronic circuit.

18. The connector unit, as recited in claim 17, wherein said inserting head of said terminal fastener has a mounting disc mounted on said first side of said supporting frame, a narrowed neck portion upwardly and integrally extended from said mounting disc, and an enlarged buckle head having a diameter substantially larger than said narrowed neck portion, wherein said receiving socket of said terminal fastener of said connector unit is shaped and sized adapted for detachably receiving and retaining said inserting head of said terminal fastener of another said connector unit therein.

19. The connector unit, as recited in claim 18, wherein said terminal fastener further comprises a resilient element formed at an opening portion of said receiving socket for applying a retaining force against said inserting head of another said terminal fastener when said inserting head of another said terminal fastener is inserted into said receiving socket of said terminal fastener.

20. The connector unit, as recited in claim 19, wherein said socket housing has a circular loop shoulder formed around said opening portion of said receiving socket to define a circular chamber surrounding said opening portion of said receiving socket and two opposed guiding slots provided along a sidewall of said opening portion of said receiving socket to communicate with said circular chamber of said loop shoulder, wherein said resilient element has two S-shaped end portions and a semi-circular middle arc portion connected between said two ends portions being arranged inside said circular chamber of said loop shoulder, wherein said middle arc portion of said resilient element is propped against an outer wall of said loop shoulder to support two straight end tails of said two end portions respectively extending into said receiving socket of said socket housing through said two guiding slots, wherein said two end tails are parallelly disposed to define a distance therebetween and smaller than a diameter of said receiving socket.

21. The connector unit, as recited in claim 17, further comprising a circuit functional element substantially supported by said supporting frame to electrically connect with said terminal fastener for performing a predetermined circuit function when said electronic circuit is formed.

22. The connector unit, as recited in claim 20, further comprising a circuit functional element substantially supported by said supporting frame to electrically connect with said terminal fastener for performing a predetermined circuit function when said electronic circuit is formed.
